(19) United States
(12) Patent Application Publication
(10) Pub. No.: US 2022/0045632 A1
(43) Pub. Date: Feb. 10, 2022

(54) MULTI-MOTOR CONVERTER

(71) Applicant: ebm-papst Mulfingen GmbH & Co. KG, Mulfingen (DE)

(72) Inventors: Sebastian SCHROTH, Kupferzell (DE); Georg WIEDMANN, Ilshofen (DE); Benedikt STOLL, Elztal-Dallau (DE)

(21) Appl. No.: 17/281,396

(22) PCT Filed: Sep. 23, 2019
(86) PCT No.: PCT/EP2019/075443

§ 371 Date: Mar. 30, 2021

(30) Foreign Application Priority Data
Oct. 1, 2018 (DE) 10 2018 124 209.3

(51) Int. Cl. H02P 5/74; H02P 6/18; H02P 21/24; H02P 21/18

(52) U.S. Cl. CPC H02P 5/74; H02P 21/18; H02P 21/24; H02P 6/188

(57) ABSTRACT

A control system (1) comprising a multi-motor converter (PWR) for the closed-loop control of a number of n EC motors (M1, . . . , Mn) operated in parallel, the rotor position of each motor being detected without a sensor and being controlled by the converter they share.

### RELATED APPLICATIONS

This application claims priority to and is a 35 U.S.C. § 371 national phase application of PCT/EP2019/075443, filed Sep. 23, 2019 and claims priority to German Patent Application No. 10 2018 124 209.3, filed Oct. 1, 2018, the entire contents of which are incorporated herein by reference in their entirety.

### FIELD

The disclosure relates to a multi-motor converter without a sensor for the parallel operation of several motors as well as a control method for operating several motors on a shared multi-motor converter.

### BACKGROUND

In order to operate an electronically commutated motor (PMSM/EC motor) without a sensor or a rotor position encoder on a converter, the voltages applied to the motor terminals as well as the currents flowing into the motor phases are normally recorded and evaluated in a suitable way and manner in order to determine the rotor position and to commutate the motor accordingly. However, there is no satisfactory solution known in the prior art for operating two or more such motors (PMSM/EC motors) on a single converter. When the term motors is used in the following description, this refers to open-loop controlled PMSM motors without a sensor or to closed-loop controlled EC motors without a sensor.

Thus, the object of the present disclosure is to provide an efficient solution for operating several motors on one converter, with said solution being economical to implement and enabling the most universally applicable use.

The disclosure is achieved by means of the features of claim 1.

### BRIEF SUMMARY

The basic idea of the disclosure is that a separate acquisition of the phase currents occurs for each of the connected motors in order to operate several, at least two, electronically commutative motors in parallel and without a rotor position encoder on a shared converter. Moreover, only a single voltage acquisition, however, is required per converter output phase, because the same terminal voltage is applied to all motors due to the parallel operation of the motors. Alternatively, it is also conceivable that the terminal voltage is not acquired but instead can be calculated from the degrees of modulation generated by the controller.

An important difference in the multi-motor converter according to the disclosure as compared to a conventional converter is the acquiring and processing of the measuring signals in order to determine the rotor position of several motors, in which, to this end, a separate current acquisition occurs for each motor connected to the multi-motor converter.

A further aspect relates to the determining of the total three-phase current Iuvw from the phase currents of the individual motors.

According to the disclosure, a control system comprising a multi-motor converter is provided for the controlled parallel operation of a number of n EC motors M1, . . . , Mn, the respective rotor position of each motor being detected without a sensor, where n≥2, comprising at least one acquisition means for determining at least the rotor positions and rotational speeds of the n EC motors with the aid of the previously measured phase currents IM1, . . . , IMn and the terminal voltage Uu,v,w of the n EC motors. The control system further has a control and transformation means in order to generate corresponding voltage variables and current variables in the d-q coordinate system (space vector system) with the aid of the determined rotor positions and the rotational speeds for controlling the n motors as well as a further control means connected downstream of the control and transformation means, to which the voltage variables and current variables generated by the upstream control and transformation means are supplied in order to generate switching commands for the multi-motor converter for operating the n motors.

According to the disclosure, the two following control means are provided alternatively.

According to a first concept, a controlled operation takes place by means of a current-phase controller. To this end, the further control means has a current-phase controller.

According to an alternative concept, a field-oriented operation takes place by means of a d-q current controller. To this end, the further control means has a d-q current controller.

In a preferred embodiment of the disclosure, it is provided that the acquisition means has at least one measuring means for acquiring the respective phase currents IM1, . . . , IMn of the n EC motors without a sensor as well as a means for determining the total currents Iuvw of then phase currents IM1, . . . , IMn.

One preferred embodiment provides that the acquisition means has means for estimating or observing and/or determining at least the rotor positions φM1, . . . , φMn and the respective rotational speed ωM1, . . . , ωMn of the n motors as well as a means for determining a theoretical and/or estimated rotor position φU and rotational speed ωU determined from the total current Iuvw and the terminal voltage Uu,v,w.

It is further advantageously provided that the control and transformation means has a Clarke-Park transformation to transform at least the acquired three-phase variables of rotor position φU and total current Iuvw into a d-q current variable Id,q_actual in the space-vector representation for the control means. In this case, dq_actual results from the measurement of the total currents Iuvw and the estimated angle φU.

In a likewise advantageous embodiment (in the case of the current-phase control) of the disclosure, it is provided that the control and transformation means has a stabilizing controller and a rotational speed controller in order to provide the voltage variables Ud_TARGET, Uq_TARGET with the d portion Ud determined from the rotor positions and rotational speeds of the n motors as well as the q portion Uq by the rotational speed controller from the rotational speed values ωtarget, ωU for the current-phase controller. The rotational speed of the assembly is estimated. The estimated rotational speed generally corresponds to the rotational speed of the two motors; however, it can also deviate therefrom (deviate from the individually estimated rotational speeds RLM1 and RLM2 of the two motors, for applications having two motors). Ud_TARGET results from the estimated variables.

It is further provided with advantage for the case of the current-phase control that the control means further has a Clarke-Park transformation in order to transform the voltage variables Ud,q in the space-vector representation obtained by the current-phase controller into a three-phase voltage variable Uuvw by means of the Clarke-Park transformation and to convert this variable into switching signals for the converter by means of a PWM modulator.

In the case of the field-oriented d-q control, it is provided that the control and transformation means has one or more stabilizing controllers and a rotational speed controller in order to provide the current variables Id_TARGET, Iq_TARGET with the d portion Id_TARGET determined from the estimated rotor positions and rotational speeds of the n motors as well as the q portion Iq_TARGET determined from the rotational speed values ωtarget, ωU for the d-q current controller.

In the case of the field-oriented control, it is further provided that the control means has a Clarke-Park transformation in order to transform the voltage variables Ud,q obtained by the d-q current controller in the space-vector representation into a three-phase voltage variable Uuvw by means of the Clarke-Park transformation and to convert this variable into switching signals for the converter by means of a PWM modulator.

The design of the rotor position estimator can take place according to a known variant as is described, for example, in DE 102015102565 A1.

A further aspect of the present disclosure relates to a method for operating n EC motors (where n≥2, i.e. with at least two EC motors) in parallel operation on a shared multi-motor converter, particularly with a control system as previously described, having the following steps:

a. acquiring the individual phase currents IM1, . . . , IMn and the terminal voltage Uu,v,w of the n EC motors;

b. determining the rotor positions and rotational speeds of the n EC motors with the aid of the previously measured phase currents IM1, . . . , IMn and the terminal voltage Uu,v,w of the n EC motors;

c. generating and transmitting current and/or voltage variables in a space-vector representation and/or in d-q space-vector coordinates to the control means with the aid of the previously determined rotor positions and the rotational speeds;

d. generating three-phase voltage variables Uuvw from the current and/or voltage variables in the space-vector representation by means of a Clarke-Park transformation and transmission of same to a modulator; and

e. generating switching commands from the voltage variables Uuvw for the multi-motor converter by means of the modulator in order to operate the n EC motors.

Explanations Regarding the Terms:

Theoretical rotational speed ωu:

ωu designates the theoretical rotational speed w of the converter, which characterizes the frequency with which the three-phase voltage system Uuvw generated by the converter rotates.

Theoretical rotor position φu:

The angle φu and accordingly the theoretical rotor position are designated as the commutation angle. Because this angle corresponds to an average angle of all motors (depending on the weighting of the individual motors), this is not a real angle but rather a theoretical angle.

d-q Current Variable Id,q_ACTUAL:

At this point, the total current of all motors is transformed with the commutation angle φu L of the converter [as previously explained] into a hypothetical current variable Id,q_ACTUAL. This is inevitably hypothetical, because no clearly determinable field-based operating current results from several motors with different potential rotor positions as a whole, or accordingly only as a control variable as relates to the hypothetical commutation angle.

d-q Voltage Variable Uu,q:

Voltage variables Du and Uq of the control system are also naturally hypothetical variables as relates to the total measured current of all motors and are accordingly used as hypothetical variables in the control.

### BRIEF DESCRIPTION OF THE DRAWINGS

Other advantageous further embodiments of the disclosure are characterized in the dependent claims and/or are shown in more detail in the following by means of the figures, along with the description of the preferred embodiment of the disclosure. The following is shown:

FIG. 1 a control system according to a first embodiment of the disclosure formed for current-phase control;

FIG. 2 a control system according to a second embodiment of the disclosure formed for field-oriented control;

FIG. 3 torque curves of both motors M1 and M2 in controlled operation;

FIG. 4 rotational speed curves in controlled operation;

FIG. 5 estimation errors in controlled operation;

FIG. 6 field-oriented current curve in controlled operation;

FIG. 7 angle difference between the two motors in controlled operation;

FIG. 8 torque curves of both motors M1 and M2 in field-oriented operation;

FIG. 9 rotational speed curves in field-oriented operation;

FIG. 10 estimation errors in field-oriented operation;

FIG. 11 field-oriented current curve in field-oriented operation;

FIG. 12 angle difference between the two motors in field-oriented operation;

FIG. 13 an equivalent circuit diagram of a rotational speed controller;

FIG. 14 an equivalent circuit diagram of the d-q current controller;

FIG. 15 an equivalent circuit diagram of a stabilizing controller; and

FIG. 16 an equivalent circuit diagram of a current-phase controller.

### DETAILED DESCRIPTION

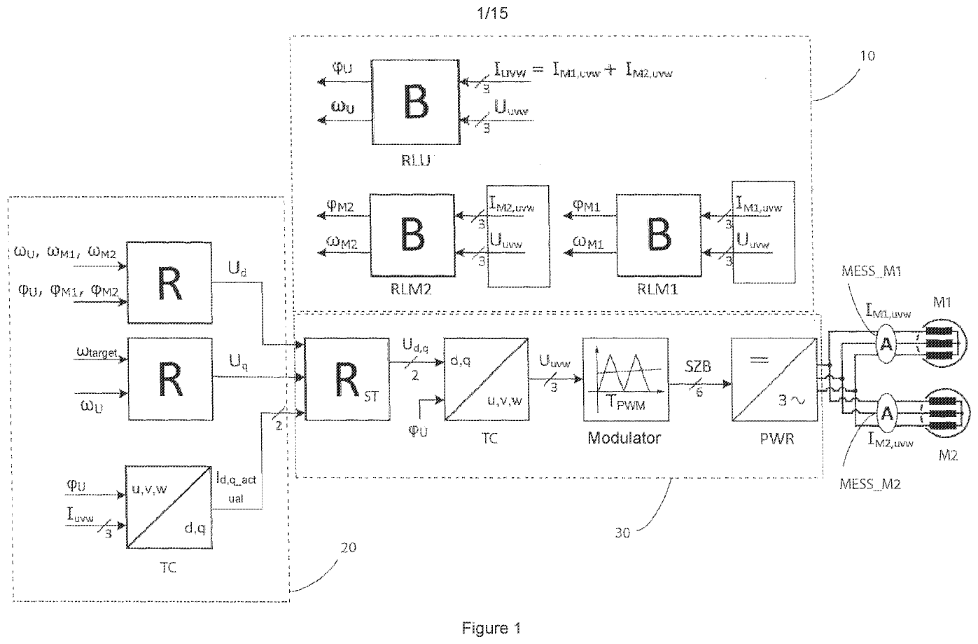

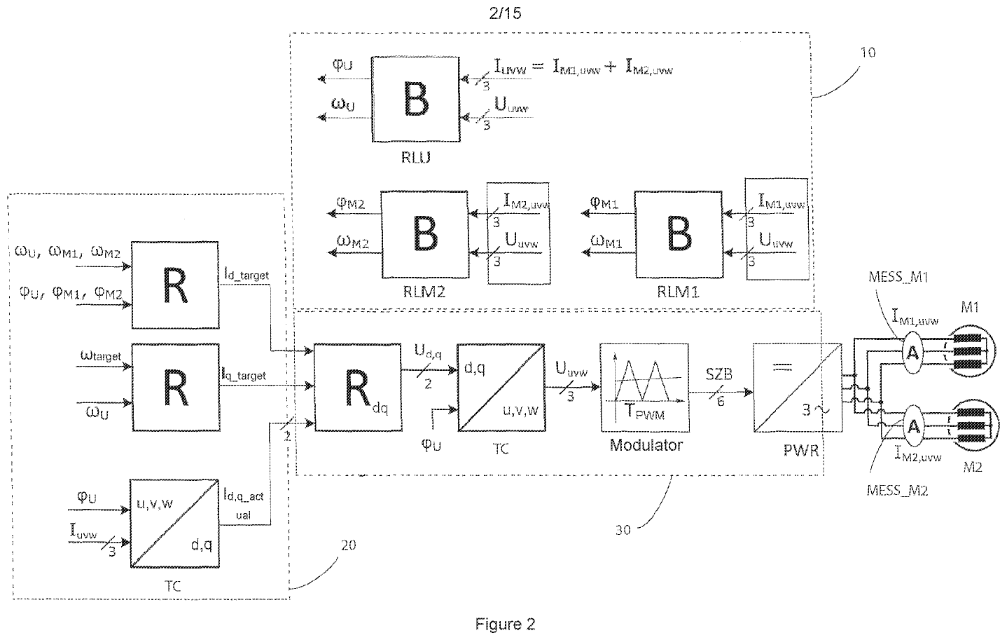

The disclosure is explained in more detail in the following by means of two embodiments with reference to FIGS. 1 and 2, wherein use of the same reference numerals in the figures indicates the same structural and/or functional features.

The two embodiments according to FIGS. 1 and 2 each show a control system 1 comprising a multi-motor converter PWR for controlled parallel operation of a number of n EC motors M1, M2, (where n=2 in this case), the respective rotor position thereof being detected without a sensor in each case.

To this end, an acquisition means 10 is provided for determining at least the rotor positions and rotational speeds of the two EC motors (M1, M2) with the aid of the previously measured phase currents IM1, . . . , IM2 and the terminal voltage Uu,v,w of the two EC motors. The acquisition means 10 is further formed to obtain the theoretical rotor position φU and the total current Iuvw, in which the total current Iuvw=IM1+IM2 and is used as an input variable for determining the variables of rotor position φU and rotational speed ωU, in addition to the terminal voltage Uuvw.

Thus, the acquisition means 10 has means RLM1, RLM2, which are formed for determining or estimating at least the rotor positions φM1, φM2 and the respective rotational speed ωM1, ωM2 of the two motors M1, M2, as well as a further means RLU for determining or estimating a theoretical rotor position φU and rotational speed ωU determined from the total current Iuvw and the terminal voltage Uu,v,w.

Furthermore, a control and transformation means 20 is provided in both embodiments in order to generate corresponding voltage variables and current variables in the d-q coordinate system with the aid of the determined rotor positions and the rotational speeds for controlling the two motors. To this end, a control means 30 is likewise provided in both embodiments downstream of the control and transformation means 20, to said control means voltage variables Ud, Uq and current variables Id,q_actual, each generated by the control and transformation means 20, and/or current variables Id_ACTUAL, Iq_ACTUAL and current variables Id,q_actual in the case of the field-oriented control are supplied in order to generate switching commands SZB for the multi-motor converter PWR in order to operate the two motors.

The control and transformation means 20 has a Clarke-Park transformation TP to transform the acquired three-phase variables of rotor position φU and total current Iuvw into a d-q current variable Id,q_actual in the space-vector representation for the control means 30.

Accordingly, FIG. 1 shows a merely schematic structure of the control with two motors, regarding which three sensorless rotor position determinations RLM1, RLM2, RLU are provided. In this case, the rotational speed controller R determines the applied voltage in the q direction, and the stabilizing controller R determines the applied voltage in the d direction, as relates to the reference coordinate system of the converter PWR in each case. The current-phase controller RST ensures the correct alignment of the applied voltages in the d-q direction by means of an angle determination from the measurement of the total phase currents. The switching commands SZB are then provided to the converter PWR according to the Clarke-Park transformation and subsequent PWM modulator.

The system according to FIG. 1 is preferably first brought to a (freely definable) limit speed of about 100 RPMs. In this case, the rotational speed controller R, the stabilizing controller R, the current-phase controller RST, as well as the rotor position determinations RLM1, RLM2, RLU deactivate or open the corresponding control loops. All control loops are then closed once the freely definable limit speed is reached.

The rotor position determinations RLM1, RLM2, RLU then require a certain amount of time until they are “steady.” This can primarily be clearly displayed in the field-oriented current curve as well as in the estimated rotational speed curve of the converter. After approximately 0.4 s, the system is completely steady, i.e. stable. At a later point in time (e.g. T=0.7 s with an exemplary embodiment), a load change occurs which re-excites the system. The aforementioned controllers respond to the measured deviations and bring the system back to a steady state.

In the design according to FIG. 2, a field-oriented control is provided in which a d-q current controller Rdq is provided in the control means 30.

In this case, the rotational speed controller R determines the target current in the q direction, and the stabilizing controller R determines the target current in the d direction (as relates to the reference coordinate system of the converter in each case). The subordinate field-oriented current controller Rdq then determines the desired voltages Ud,q in the d-q direction by means of comparison with the total measured phase currents Id,q_ACTUAL. The switching commands SZB are then provided to the multi-motor converter PWR according to the Clarke-Park transformation and subsequent PWM modulator.

As can likewise be seen in FIGS. 1 and 2, the acquisition means 10 comprises a measuring means A for sensorless acquisition of the respective phase currents IM1, IM2 of the two EC motors M1, M2 as well as the total currents Iuvw of the two phase currents.

The control means 30 according to FIG. 1 further has a Clarke-Park transformation TC in order to transform the voltage variables Ud,q in the space-vector representation obtained by the current-phase controller RST into a three-phase voltage variable Uuvw by means of the Clarke-Park transformation and to convert this variable into switching signals SZB for the converter PWR by means of a PWM modulator PWM.

In the design according to FIG. 2, the control and transformation means 20 comprises a stabilizing controller R and a rotational speed controller R in order to provide the current variables Id_TARGET, Iq_TARGET with the d portion Id_TARGET determined from the rotor positions and rotational speeds of the two motors as well as the q portion Iq_TARGET determined from the rotational speed values ωtarget, ωU for the d-q current controller Rdq. The control means 30 further has a Clarke-Park transformation TC in order to transform the voltage variables Ud,q in the space-vector representation obtained by the d-q current controller Rdq into a three-phase voltage variable Uuvw by means of the Clarke-Park transformation and to convert this variable into switching signals SZB for the converter PWR by means of the PWM modulator.

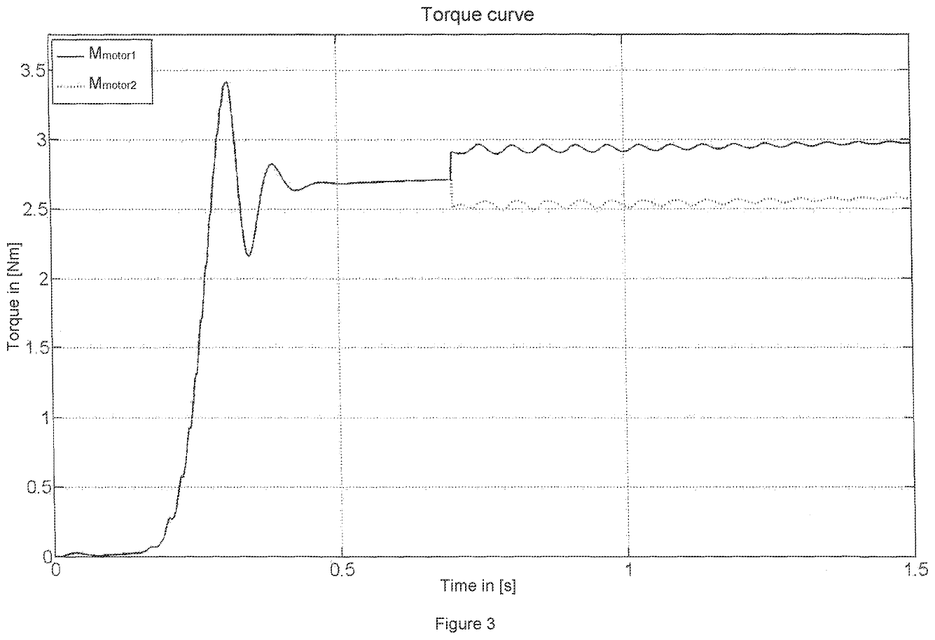

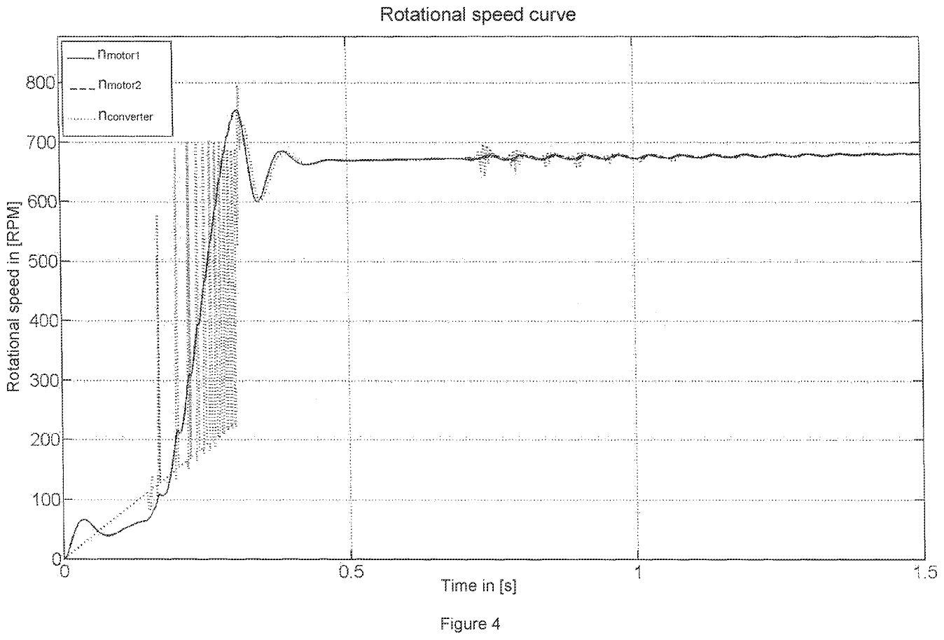

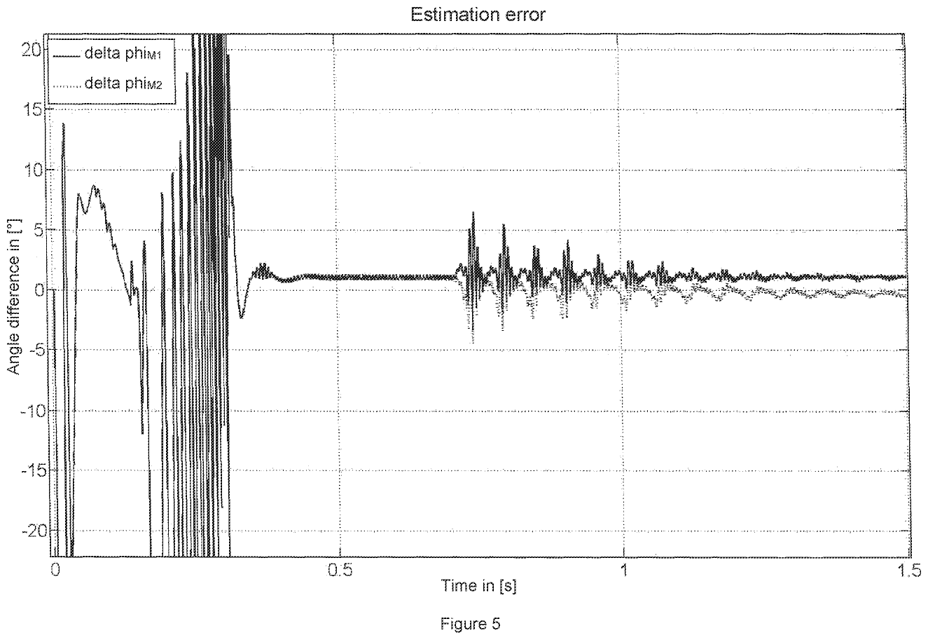

FIGS. 3 to 7 show an exemplary operation when using the multi-motor control in controlled operation. The system is first brought to a limit speed of about 100 RPMs. In this case, the rotational speed controller, the stabilizing controller, the current-phase controller, as well as the rotor position determinations are initially deactivated.

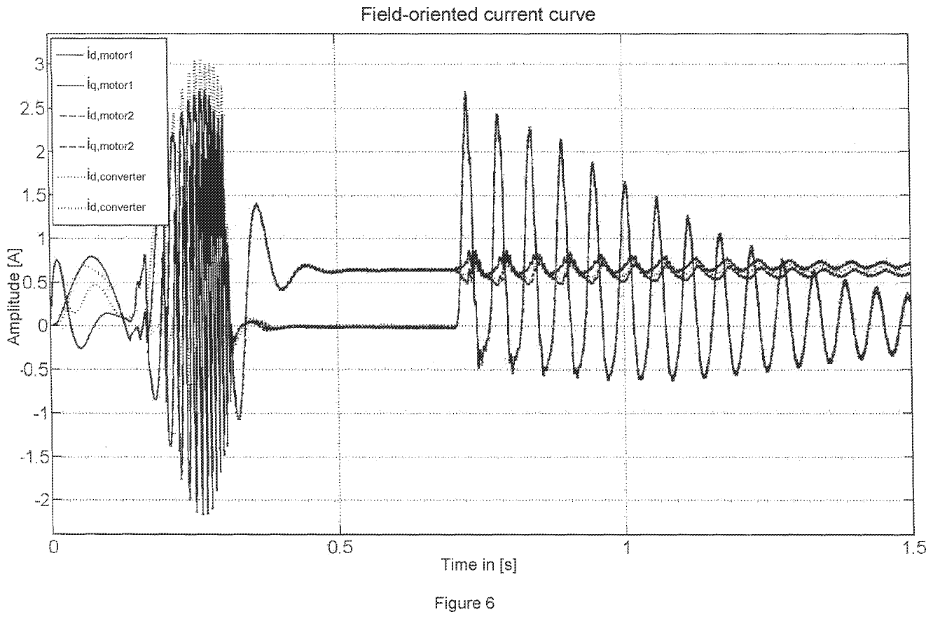

All control loops are closed once the freely definable limit speed is reached. The position determinations then require a certain amount of time until they are steady. This is primarily noticeable in the field-oriented current curves (see FIG. 6) as well as in the estimated rotational speed curve of the converter (see FIG. 2). After approximately 0.4 s, the system is completely steady. At a point in time of about t=0.7 s, a load change occurs which re-excites the system. The controllers respond to the measured deviations and bring the system back to the steady state.

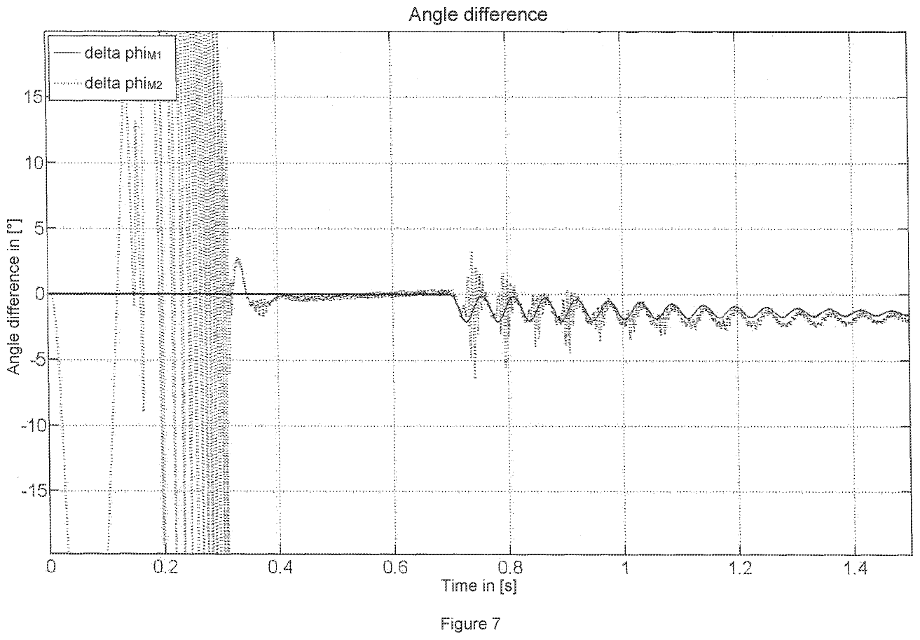

The difference between the estimated commutation angle of the converter and the actual angles of rotation of motors M1 and M2 can be seen in the diagram on angle difference (see FIG. 7). Before the load change, there is an angle difference of practically zero in the steady state. After the load change at approximately 0.7 s, there is a deviation (angle difference) of about 2°.

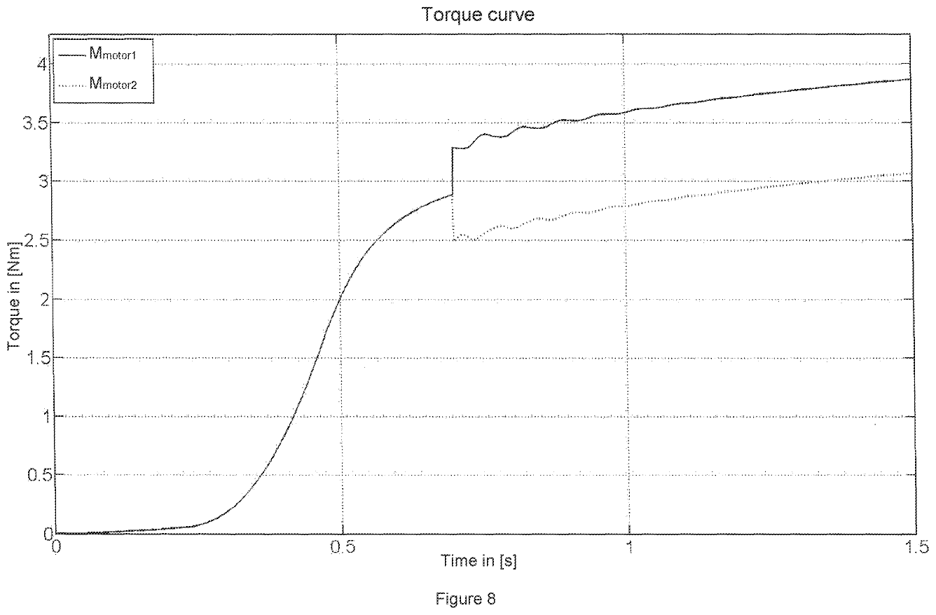

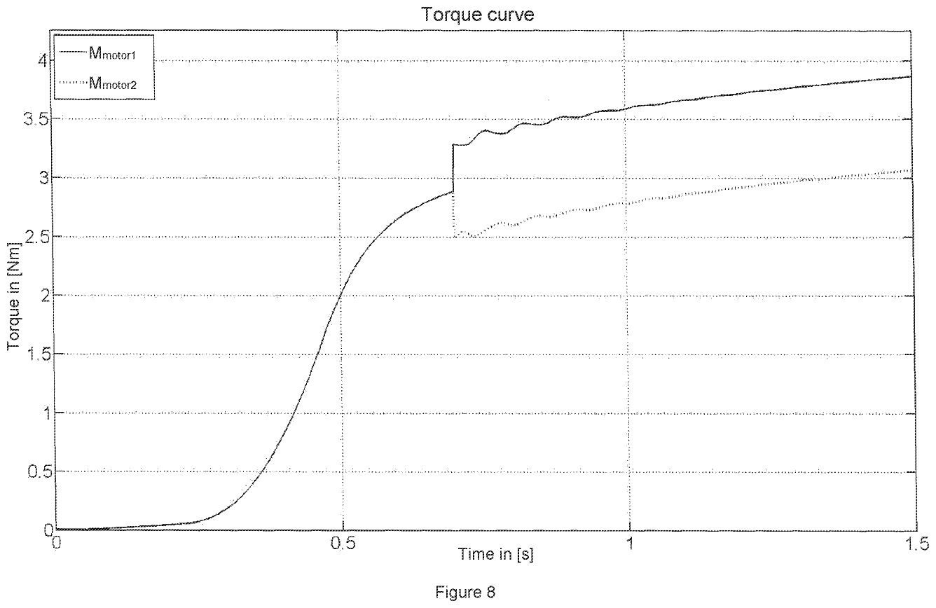

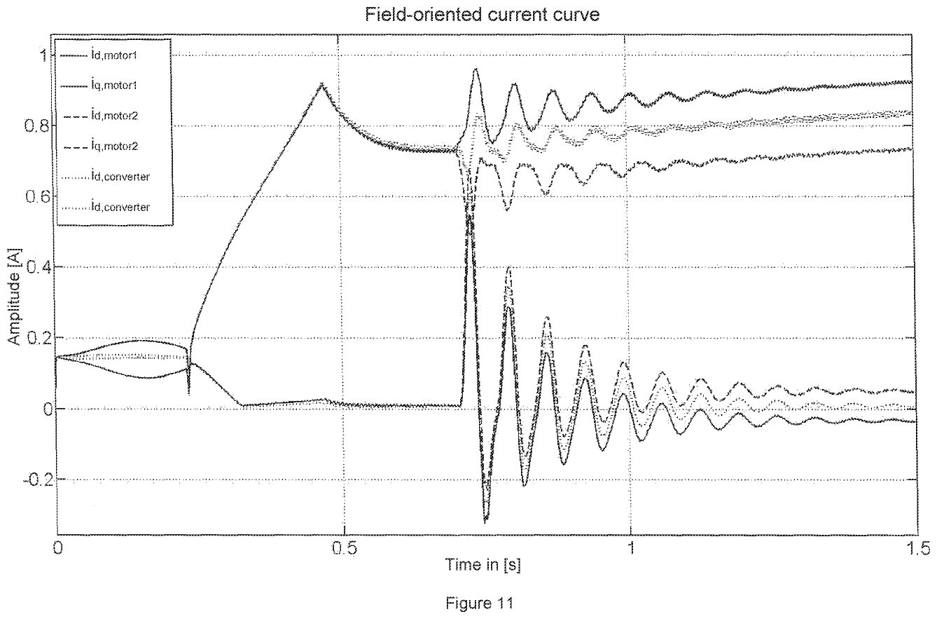

FIGS. 8 to 12 show the system behavior when the multi-motor control is used for operation with the aid of an FOC (field-oriented control). In this case as well, the system is first brought to a limit speed of about 100 RPMs.

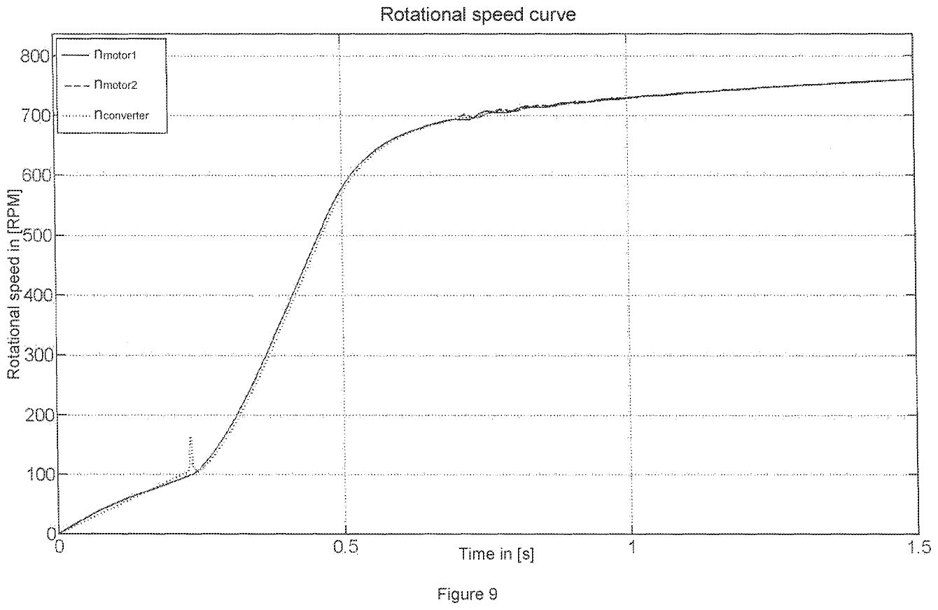

In this case, the rotational speed controller, the stabilizing controller, as well as the rotor position determinations are deactivated. All control loops are closed once the freely definable limit speed is reached. The system becomes steady relatively quickly here. Only a brief peak can be seen in the estimated rotational speed of the converter (see FIG. 9). At a point in time of about t=0.7 s, a load change occurs which re-excites the system.

The controllers respond to the measured deviations and bring the system back to a steady state. The steady state is also established relatively quickly in this case.

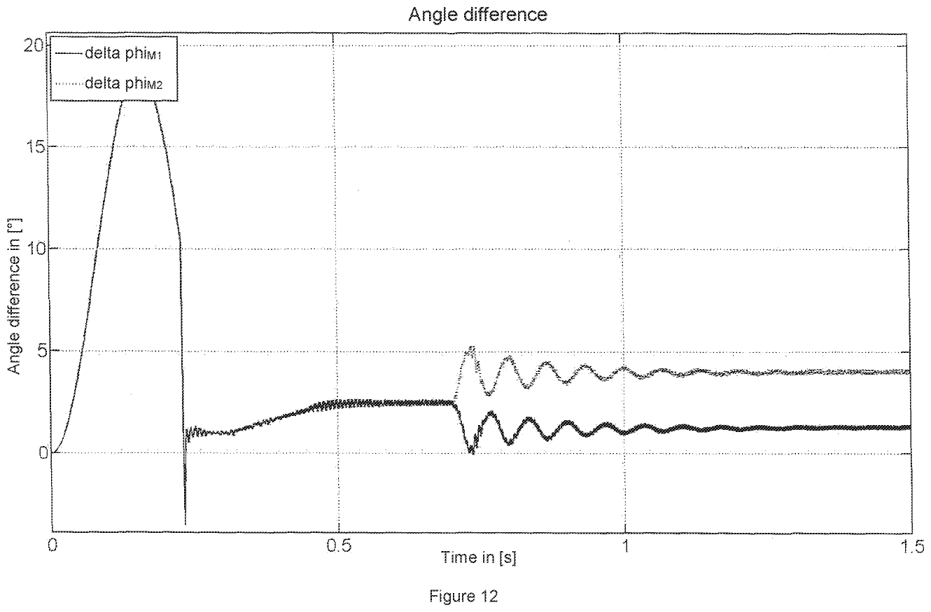

The difference between the estimated commutation angle of the converter and the actual angles of rotation of motors M1 and M2 can be seen in the diagram on angle difference in FIG. 12. Before the load change, there is an angle difference of approximately 2.5° in the steady state. The reason for this is that a parameter deviation of 20% was specified for motors M1 and M2. After the load change, there is a deviation of 2 or 4° in the angle difference. This is within the range to be expected, because the coordinate systems of the motors and of the converter continue to turn toward one another due to the now differing loads.

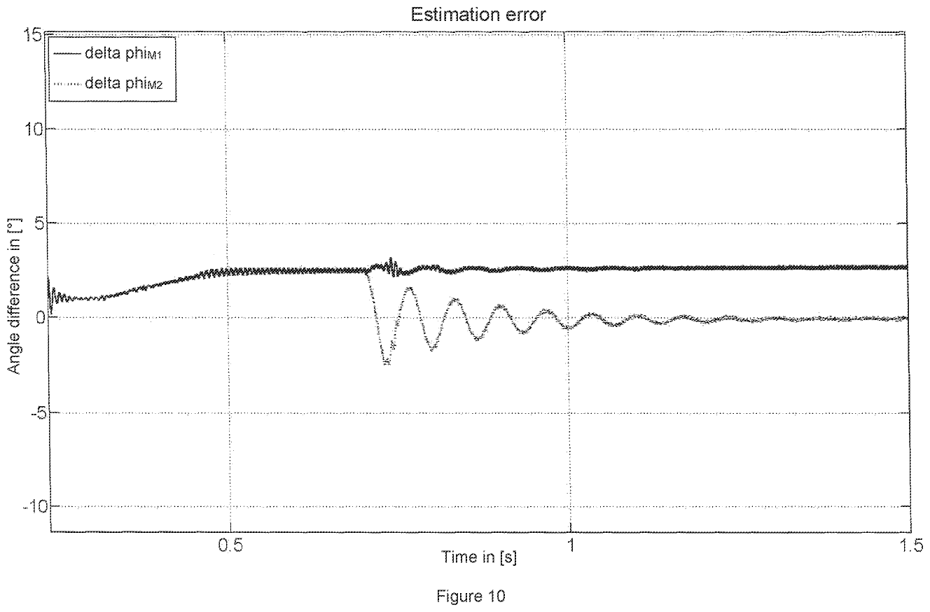

The respectively current estimated error between the actual angle of rotation of the motor and the estimated angle of rotation of the motor is plotted in the diagram regarding estimation errors in FIG. 10. Before the load change, the estimated error is approximately 2°.

After the load change, the less loaded motor M1 achieves an estimation error of practically zero, while the estimation error remains basically unchanged with the more strongly loaded motor M2.

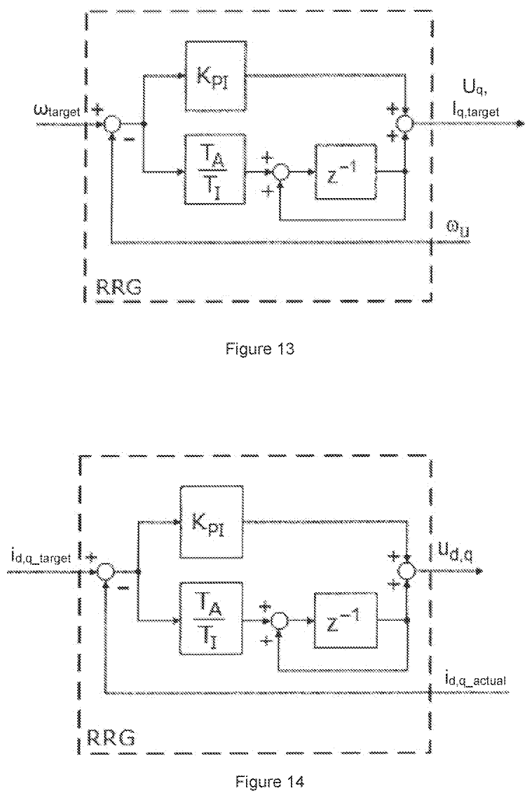

FIG. 13 shows an equivalent circuit diagram of a rotational speed controller. This is constructed in the form of a conventional PI controller. In this case, the actual rotational speed ωu determined by the sensorless rotor position estimator is compared to the target rotational speed ωtarget defined by control software, and the difference is provided to the PI controller. It then determines the target current I_{d},target and/or the voltage Uq to be applied in the q direction.

FIG. 14 shows an equivalent circuit diagram of a current controller. This is constructed in the form of a conventional PI controller. In this case, the total measured current Id,q_ACTUAL of all motors is compared to the target current Id,target, Iq, target determined with the superposed rotational speed controller, and the difference is provided to the PI controller. It then determines, at its output, the voltages Ud,q to be applied in the d and/or q direction.

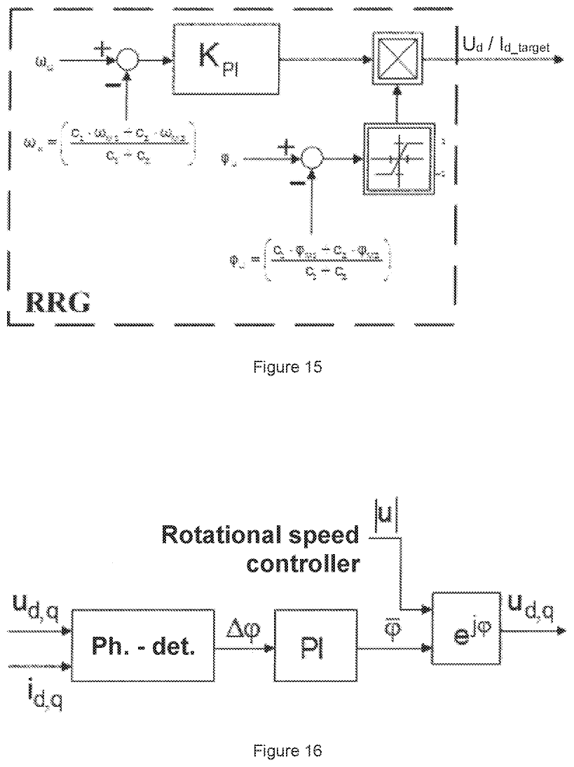

FIG. 15 shows an equivalent circuit diagram of a stabilizing controller. There is essentially a plurality of conceivable design variants for a stabilizing controller. One advantageous variant would be, for example, the determination of a d component as a function of the absolute size of the rotational speed difference. A further potential variant is depicted above. In this case, the rotational speed at which the converter coordinate system rotates is compared to the estimated and subsequently suitably weighted rotational speeds of the motors [two motors in this case as an example] and provided to a P controller. The output of the P controller is then multiplied by an angle difference determined in the same way and manner. This angle difference is limited to a value range between 1 and −1.

FIG. 16 shows an equivalent circuit diagram of a current-phase controller and the functional method thereof. One component of the current-phase controller is a phase detector. It determines the angle error as relates to the desired d current portion from the imported and subsequently transformed phase currents. The subsequent PI controller is responsible for regulating the necessary average phase offset and for obtaining the desired d and q portions in the current. The PI controller is constructed just like the previously described current and rotational speed controller.

The disclosure is not limited in its design to the aforementioned preferred exemplary embodiments. Rather, a number of variants is conceivable, which would make use of the solution shown even with essentially different designs.

1. A control system comprising a multi-motor converter (PWR) for controlled parallel operation of a number (n) of EC motors (M1, . . . , Mn), the respective rotor position of which being acquired without a sensor, where n≥2, comprising:
a. at least one acquisition means for determining at least the rotor positions and rotational speeds of the EC motors (M1, . . . , Mn) with the aid of previously measured phase currents IM1, . . . , IMn;
b. a control and transformation means configured to generate corresponding voltage variables and current variables in a d-q coordinate system with the aid of the determined rotor positions and the rotational speeds for controlling the EC motors;
c. a control means downstream of the control and transformation means, the control means receiving the voltage variables and current variables generated by the control and transformation means and configured to generate switching commands (SZB) therefrom for the multi-motor converter in order to operate the EC motors.

2. The control system according to claim 1, wherein the control means has a current-phase controller (RST).

3. The control system according to claim 1, wherein the control means has a d-q current controller Rdq.

4. The control system according to claim 1, wherein the acquisition means has at least one measuring means (A) for the sensorless acquisition of the respective phase currents IM1, . . . , IMn of then EC motors (M1, . . . , Mn).

5. The control system according to claim 4, wherein the at least one acquisition means for determining at least the rotor positions and rotational speeds of the EC motors (M1, . . . , Mn) is aided by the terminal voltage Uu,v,w of the EC motors (M1 . . . , , Mn), and wherein the acquisition means has determining means (RLM1, . . . , RLMn) for determining or estimating at least the rotor positions φM1, . . . , φMn and the respective rotational speed ωMn1, . . . , ωMn of the EC motors (M1, . . . , Mn) as well as a determining means for determining a theoretical rotor position φU and rotational speed ωU determined from a total current Iuvw and the terminal voltage Uu,v,w.

6. The control system according to claim 1, wherein the control and transformation means has a Clarke-Park transformation (TP) to transform at least the three-phase variables of rotor position φU and total current Iuvw into a d-q current variable Id,q_actual in the space-vector representation for the control means.

7. The control system according to claim 2, wherein the control and transformation means has a stabilizing controller (R) in order to provide the voltage variables Ud, Uq with the d portion Ud determined from the rotor positions and rotational speeds of the EC motors as well as the q portion Uq determined from the rotational speed values ωtarget, ωU for the current-phase controller (RST).

8. The control system according to claim 2, wherein the control means has a Clarke-Park transformation (TC) in order to transform voltage variables Ud,q in the space-vector representation obtained by the current-phase controller (RST) into a three-phase voltage variable Uuvw by means of the Clarke-Park transformation and to convert this variable into direct-voltage switching signals (SZB) for the converter (PWR) by means of a PWM modulator (PWM).

9. The control system according to claim 3, wherein the control and transformation means has a stabilizing controller (R) in order to provide the current variables Id_TARGET, Iq_TARGET with the d portion Id_TARGET determined from the rotor positions and rotational speeds of the n motors as well as the q portion Iq_TARGET determined from the rotational speed values ωtarget, ωU for the d-q current controller (Rdq).

10. The control system according to claim 3, wherein the control means has a Clarke-Park transformation (TC) in order to transform the voltage variables Ud,q obtained by the d-q current controller (Rdq) in the space-vector representation into a three-phase voltage variable Uuvw by means of the Clarke-Park transformation and to convert this variable into switching signals (SZB) for the converter (PWR) by means of a PWM modulator (PWM).

11. A method for operating and number (n) of EC motors, where n≥2, in parallel operation on a shared multi-motor converter (PWR) having a control system according to claim 1, with the following steps:
a. acquiring the individual phase currents IM1, . . . ;
b. determining the rotor positions and rotational speeds of the n EC motors (M1, . . . , Mn) with the aid of the previously measured phase currents IM1, . . . , IMn;
c. generating and transmitting current and/or voltage variables in a space-vector representation to the control means with the aid of the determined rotor positions and the rotational speeds;
d. generating three-phase voltage variables Uuvw from the current and/or voltage variables in the space-vector representation by means of a Clarke-Park transformation and transmission of same to a modulator (PWM);
e. generating switching commands (SZB) from the voltage variables Uuvw for the multi-motor converter (PWR) by means of the modulator (PWM) in order to control operation of the n EC motors.

12. The control system according to claim 1, wherein the at least one acquisition means for determining at least the rotor positions and rotational speeds of the EC motors (M1, . . . , Mn) is aided by the terminal voltage Uu,v,w of the EC motors (M1, . . . , Mn).

13. The method according to claim 11, wherein the at least one acquisition means for determining at least the rotor positions and rotational speeds of the EC motors (M1, . . . , Mn) is aided by the terminal voltage Uu,v,w of the EC motors (M1, . . . , Mn), and wherein the step of acquiring the individual phase currents IM1, . . . , IMn includes acquiring a terminal voltage Uu,v,w of the EC motors (M1, . . . , Mn), and wherein the step of determining the rotor positions and rotation speeds of the EC motors is with the aid of the terminal voltage Uu,v,w of then EC motors (M1, . . . , Mn).
